(19) United States
(12) Patent Application Publication
(10) Pub. No.: US 2009/0109512 A1
(43) Pub. Date: Apr. 30, 2009

(54) MEMS SCANNER HAVING ACTUATOR SEPARATED FROM MIRROR

(75) Inventor: Yong-hwa Park, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/054,615

(22) Filed: Mar. 25, 2008

(30) Foreign Application Priority Data
Oct. 24, 2007 (KR) 10-2007-0107433

(51) Int. Cl. G02B 26/10

(52) U.S. Cl. 359/199.2; 359/198.1; 359/199.3

(57) ABSTRACT

A microelectromechanical systems (MEMS) scanner is provided. The MEMS scanner includes: a stationary frame; a first movable stage disposed inside the stationary frame and suspended on the stationary frame so as to pivot and vibrate around a virtual center shaft; a second movable stage disposed inside the first movable stage and suspended on the first movable stage so as to pivot and vibrate around the center shaft; and an actuator providing a driving force used to pivot and vibrate the first movable stage.

### CROSS-REFERENCE TO RELATED PATENT APPLICATIONS

This application claims priority from Korean Patent Application No. 10-2007-0107433, filed on Oct. 24, 2007, in the Korean Intellectual Property Office, the disclosure of which is incorporated herein in its entirety by reference.

### BACKGROUND OF THE INVENTION

1. Field of the Invention

Apparatuses consistent with the present invention relate to a microelectromechanical systems (MEMS) scanner, and more particularly, to a MEMS scanner in which a mirror is separated from an actuator and is indirectly driven.

2. Description of the Related Art

Recently, researches on MEMS devices fabricated by semiconductor processes have been actively performed in the technical fields of displays, printers, precision measurement, and precision processing. For example, with regard to a display in which light incident from a light source is scanned in a predetermined screen region and an image is realized, or with regard to a scanner in which light is scanned in a predetermined screen region and reflected light is received and image information is read, a MEMS device has been highlighted for use as an optical scanner.

In particular, as the printing technology has advanced, high-speed, silentious, and small and light printers are required. Thus, one general solution in this regard is to replace a polygonal mirror and an f-O optical system, which are used in a laser scanning unit (LSU) of a related art printer, with a MEMS scanner and arcsine mirror. In addition, such MEMS scanner can be manufactured to have a small size by silicon semiconductor processes, is suitable for mass production, and the manufacturing costs are low.

A related art electromagnetic MEMS scanner may be classified into a moving coil type electromagnetic MEMS scanner and a moving magnet type electromagnetic MEMS scanner. In the moving coil type electromagnetic MEMS scanner, a coil is attached to a mirror and a magnet is disposed outside of the mirror. The moving coil type electromagnetic MEMS scanner is suitable for small-sized printers. However, a manufacturing process of the same is complicated, the mirror is deformed by thermal deformation of the coil when it operates, and it is not easy to keep high flatness of a reflection surface. In the moving magnet type electromagnetic MEMS scanner, the magnet is attached to the mirror and the coil is disposed outside of the mirror, a manufacturing process of the same is comparatively simple. However, the mass of an operating portion increases. Thus, the moving magnet type electromagnetic MEMS scanner is not suitable for small-sized printers, and mass eccentricity and stress concentration occur.

### SUMMARY OF THE INVENTION

The present invention provides a MEMS scanner having an improved structure in which a mirror is separated from an actuator and is indirectly driven.

According to an aspect of the present invention, there is provided a MEMS scanner comprising: a stationary frame; a first movable stage disposed inside the stationary frame and suspended on the stationary frame so as to pivot and vibrate around a virtual center shaft; a second movable stage disposed inside the first movable stage and suspended on the first movable stage so as to pivot and vibrate around the virtual center shaft; and an actuator providing a driving force used to pivot and vibrate the first movable stage.

The first movable stage may be directly driven by the actuator and the second movable stage may be indirectly driven by driving the first movable stage.

A reflection surface from which incident light is reflected may be provided on at least one of an upper surface and a bottom surface of the second movable stage.

The stationary frame, the first movable stage and the second movable stage may be formed on one silicon substrate as one body.

The stationary frame and the first movable stage may be connected to each other by at least one first tortional spring disposed therebetween and the first movable stage and the second movable stage may be connected to each other by at least one second tortional spring disposed therebetween. The first tortional spring may have larger rigidity than the second tortional spring.

The first tortional spring and the second tortional spring may be placed on the center axis and have a shape of a bar extending along the center axis. The first tortional spring may have a larger thickness than the second tortional spring.

The first tortional spring may have a folded shape. In this case, two first tortional springs may be provided at each of two facing edges of the first movable stage or at each of four edges of the first movable stage.

The actuator may be an electromagnetic actuator comprising permanent magnets and an electromagnet.

The permanent magnets may be attached to each of both sides of the bottom surface of the first movable stage. In this case, the permanent magnets may be attached to the first movable stage so that the same magnetic poles point in the same direction.

The electromagnet may comprise a core and a coil wound around the core, and both ends of the core may face each other and may be spaced apart from each of the permanent magnets by a predetermined distance.

According to another aspect of the present invention, the actuator may be an electrostatic actuator comprising movable combs and stationary combs. In this case, the stationary combs may be disposed at different heights from those of the moveable combs in a vertical direction so that an electrostatic force is applied to the movable combs in the vertical direction.

The actuator may further comprise stationary stages disposed under both sides of the first movable stage and supporting the stationary combs.

The movable combs may protrude from both sides of the first movable stage in a horizontal direction and the stationary combs may protrude from one side of each of the stationary stages in the horizontal direction, and may be disposed not to overlap the movable combs.

### BRIEF DESCRIPTION OF THE DRAWINGS

The above and other aspects of the present invention will become more apparent by describing in detail preferred embodiments thereof with reference to the attached drawings, in which:

FIG. 1 is a perspective view illustrating a MEMS scanner according to an exemplary embodiment of the present invention;

FIG. 2 is a sectional view of the MEMS scanner taken along line A-A′ of FIG. 1, according to an exemplary embodiment of the present invention;

FIG. 3 illustrates an equivalent system for vibrating a first movable stage and a second movable stage of the MEMS scanner of FIG. 1, according to an exemplary embodiment of the present invention;

FIG. 4 is a perspective view illustrating a MEMS scanner according to another exemplary embodiment of the present invention;

FIG. 5 is a sectional view of the MEMS scanner taken along line B-B′ of FIG. 4, according to an exemplary embodiment of the present invention;

FIGS. 6 and 7 are plane views illustrating modified examples of the MEMS scanner of FIG. 1, according to an exemplary embodiment of the present invention and

FIG. 8 is a plane view illustrating a modified example of the MEMS scanner of FIG. 4, according to an exemplary embodiment of the present invention.

### DETAILED DESCRIPTION OF EXEMPLARY EMBODIMENTS

Hereinafter, the present invention will be described in detail by explaining exemplary embodiments of the invention with reference to the attached drawings. Like reference numerals in the drawings denote like elements.

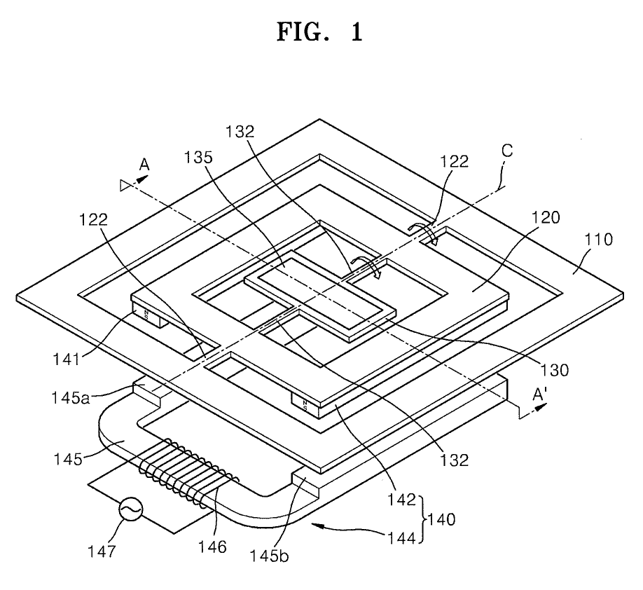

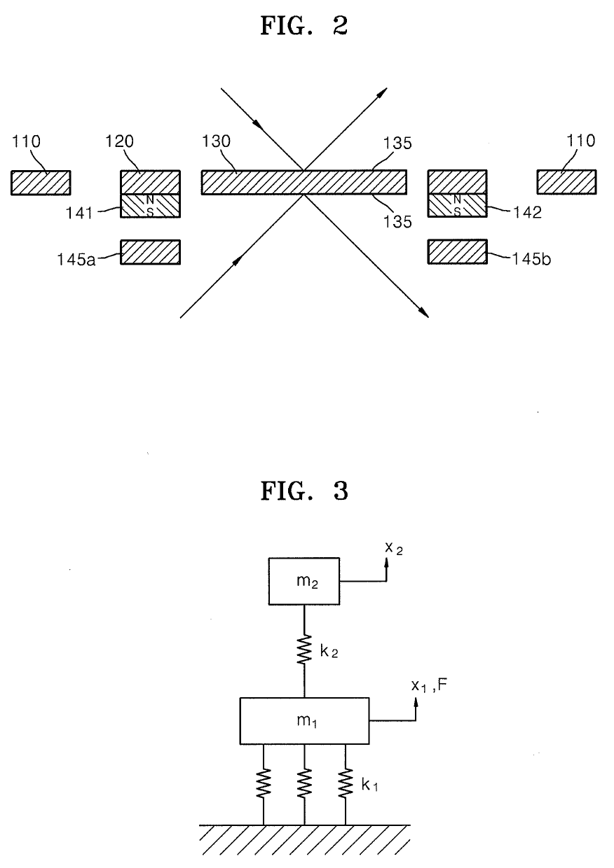

FIG. 1 is a perspective view illustrating a MEMS scanner according to an exemplary embodiment of the present invention, and FIG. 2 is a sectional view of the MEMS scanner taken along line A-A′ of FIG. 1.

Referring to FIGS. 1 and 2, the MEMS scanner according to an exemplary embodiment of the present invention comprises a stationary frame 110, a first movable stage 120, a second movable stage 130, and an electromagnetic actuator 140.

The stationary frame 110 is plate-shaped and has a predetermined thickness. The first movable stage 120 is disposed inside the stationary frame 110. The first movable stage 120 is suspended on the stationary frame 110 so as to pivot and vibrate around a virtual center shaft C by a predetermined angle. To this end, the stationary frame 110 and the first movable stage 120 may be connected to each other by a first tortional spring 122 disposed therebetween. The first tortional spring 122 may be placed on the virtual center shaft C and may have the shape of a bar extending along the virtual center shaft C.

The second movable stage 130 is disposed inside the first movable stage 120 and is suspended on the first movable stage 120 so as to pivot and vibrate around the virtual center shaft C at a predetermined angle. To this end, the first movable stage 120 and the second movable stage 130 may be connected to each other by a second tortional spring 132 disposed therebetween. The second tortional spring 132 may be placed on the virtual center shaft C and may have the shape of a bar extending along the virtual center shaft C.

A reflection surface 135 from which incident light is reflected, that is, a mirror, may be provided on the upper surface of the second movable stage 130. In addition, as will be described later, the reflection surface 135 may be provided on the bottom surface of the second movable stage 130.

The stationary frame 110, the first movable stage 120, the second movable stage 130, the first tortional spring 122 and the second tortional spring 132 may be formed on one silicon wafer as one body. As such, a manufacturing process of the MEMS scanner may be simplified.

The electromagnetic actuator 140 pivots and vibrates the first movable stage 120 and may comprise permanent magnets 141 and 142, and an electromagnet 144 disposed therebelow. The permanent magnets 141 and 142 may be attached to two opposite sides of the bottom surface of the first movable stage 120, respectively. The permanent magnets 141 and 142 may be attached to the first movable stage 120 so that the same magnetic poles, for example, the S poles of the permanent magnets 141 and 142, point in the same direction, for example, a downward direction. The electromagnet 144 may comprise a core 145 and a coil 146 wound around the middle portion of the core 145. Two ends 145a and 145b of the core 145 may face each other and be spaced apart from each of the permanent magnets 141 and 142 by a predetermined distance.

In the electromagnetic actuator 140 having the above structure, when an alternating current (AC) voltage having a predetermined frequency is applied to the coil 146 from an electric power source 147, polarities of both ends 145a and 145b of the core 145 vary according to the direction of current. As such, due to a mutual attraction force or a repulsive force formed between the permanent magnets 141 and 142 and both ends 145a and 145b of the core 145, the first movable stage 120 pivots and vibrates around the virtual center shaft C with a predetermined frequency. Pivoting and vibrating of the first movable stage 120 causes pivoting and vibrating of the second movable stage 130 suspended on the first movable stage 120, as will be described later. In other words, the first movable stage 120 is directly driven by the electromagnetic actuator 140, and the second movable stage 130 having the reflection surface 135 pivots and vibrates indirectly due to pivoting and vibrating of the first movable stage 120.

As described above, in the MEMS scanner illustrated in FIG. 1, since a coil, a magnet, or the like is not attached to the second movable stage 130 having the reflection surface 135, the mass of the second movable stage 130 can be minimized. As such, the size of the second tortional spring 132 supporting the second movable stage 130 can be reduced, and stress to be applied thereto can also be reduced. Thus, the structural reliability of the MEMS scanner can be improved, and the maximum rotation speed of the second movable stage 130 can also be increased.

The permanent magnets 141 and 142 are attached to the first movable stage 120, as described above. Thus, the first tortional spring 122 supporting the first movable stage 120 may have sufficiently larger rigidity than the rotation rigidity of the first movable stage 120 so as to prevent a damage that may occur when the permanent magnets 141 and 142 are attached to the first movable stage 120 and to be solid with respect to an external shock or the like. The first tortional spring 122 supporting the first movable stage 120 may have larger rigidity than that of the second tortional spring 132. Specifically, the width of the first tortional spring 122 may be larger than that of the second tortional spring 132. As such, the resonant frequency of the first tortional spring 122 is higher than that of the second tortional spring 132.

Since a coil, a magnet, or the like is not attached to the second movable stage 130, the reflection surface 135, that is, a mirror, may be provided on both the upper surface and the bottom surface of the second movable stage 130. As such, the number of scanners used in an LSU is reduced by half, the size of the LSU is reduced, and manufacturing costs thereof can be reduced.

FIG. 3 illustrates an equivalent system for vibrating a first movable stage and a second movable stage of the MEMS scanner of FIG. 1.

As illustrated in FIG. 3, the MEMS scanner of FIG. 1 may be equivalent to a dynamic model having the degree of freedom (DOF) equal to 2. Specifically, the first movable stage 120 and the second movable stage 130, which are movable elements, may be modeled as mass m1 and m2, respectively, and respective rotation displacement may be indicated by x1 and x2. The first tortional spring 122 and the second tortional spring 132 may be modeled with rotation rigidity k1 and k2, respectively. On the other hand, a damping element of the first movable stage 120 and the second movable stage 130 is small and thus may be neglected.

Referring to FIG. 3, when an external force F is applied to the first movable stage 120 corresponding to mass m1, the first movable stage 120 moves by the displacement x1. A value which is obtained by multiplying the displacement x1 of the first movable stage 120 by the rotation rigidity k2 of the second tortional spring 130 acts as a vibration force on the second movable stage 130 corresponding to mass m2. In this case, when a vibration force is applied to the first movable stage 120 with the resonant frequency of the second movable stage 130 through the electromagnetic actuator 140, the second movable stage 130 having the reflection surface 135 causes resonance and moves by the maximum displacement x2.

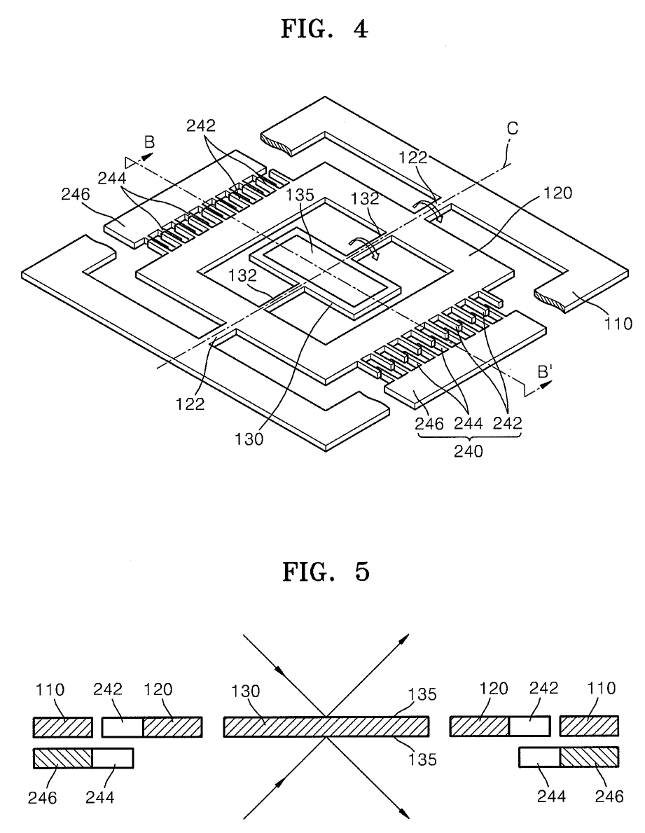

FIG. 4 is a perspective view illustrating a MEMS scanner according to another exemplary embodiment of the present invention, and FIG. 5 is a sectional view of the MEMS scanner taken along line B-B′ of FIG. 4.

Referring to FIGS. 4 and 5, the MEMS scanner according to another exemplary embodiment of the present invention comprises a stationary frame 110, a first movable stage 120, a second movable stage 130, and an electrostatic actuator 240.

The first movable stage 120 is disposed inside the stationary frame 110 and is suspended by a first tortional spring 122 on the stationary frame 110 so as to pivot and vibrate around a virtual center shaft C by a predetermined angle. The second movable stage 130 is disposed inside the first movable stage 120, and is suspended by a second tortional spring 132 on the first movable stage 120 so as to pivot and vibrate around the virtual center shaft C by a predetermined angle. A reflection surface 135 on which incident light is reflected, that is, a mirror, may be provided on both the upper surface and the bottom surface of the second movable stage 130. The stationary frame 110, the first movable stage 120, the second movable stage 130, the first tortional spring 122 and the second tortional spring 132 are the same as those of the MEMS scanner of FIG. 1, and thus a detailed description thereof will be omitted.

The electrostatic actuator 240 pivots and vibrates the first movable stage 120, and may comprise movable combs 242 provided on the first movable stage 120 and stationary combs 244 formed on stationary stages 246. The movable combs 242 may protrude from two opposite sides of the first movable stage 120 in a horizontal direction. The stationary stages 246 are disposed under the two opposite sides of the first movable stage 120, and the stationary combs 244 protrude from two sides of the stationary stages 246 in a horizontal direction, and are disposed not to overlap the movable combs 242. The stationary combs 244 are disposed at different heights from the moveable combs 242 so that an electrostatic force is applied to the movable combs 242 in a vertical direction.

In the electrostatic actuator 240 having the above structure, an electrostatic force is applied to the movable combs 242 in a vertical direction according to a difference between voltages applied to the movable combs 242 and the stationary combs 244, and the first movable stage 120 pivots and vibrates around the virtual center shaft C according to the direction of the electrostatic force. Pivoting and vibrating of the first movable stage 120 causes pivoting and vibrating of the second movable stage 130 suspended on the first movable stage 120. In other words, the first movable stage 120 may be directly driven by the electrostatic actuator 240, and the second movable stage 130 having the reflection surface 135 may be indirectly driven by pivoting and vibrating of the first movable stage 120.

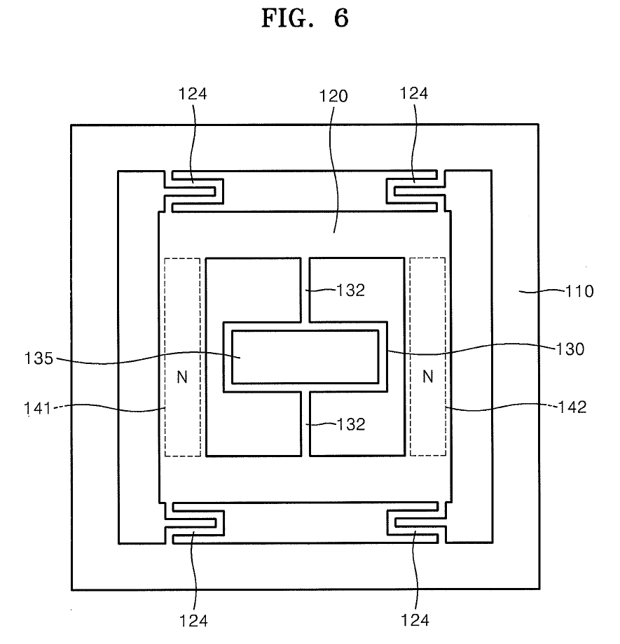

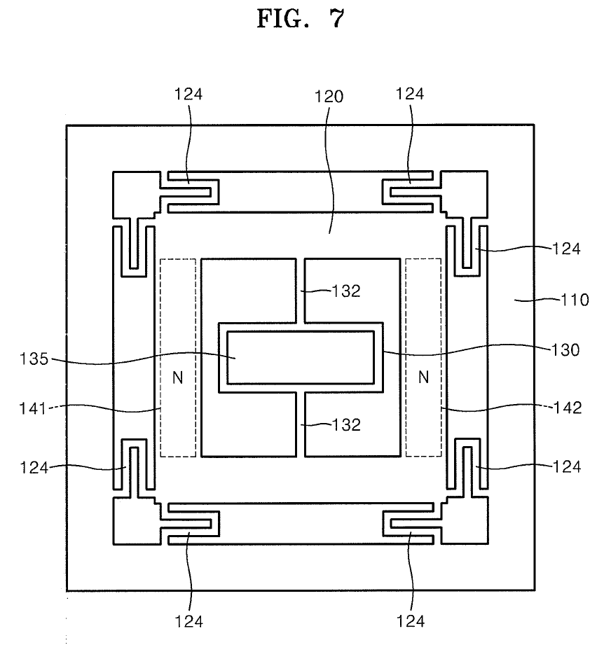

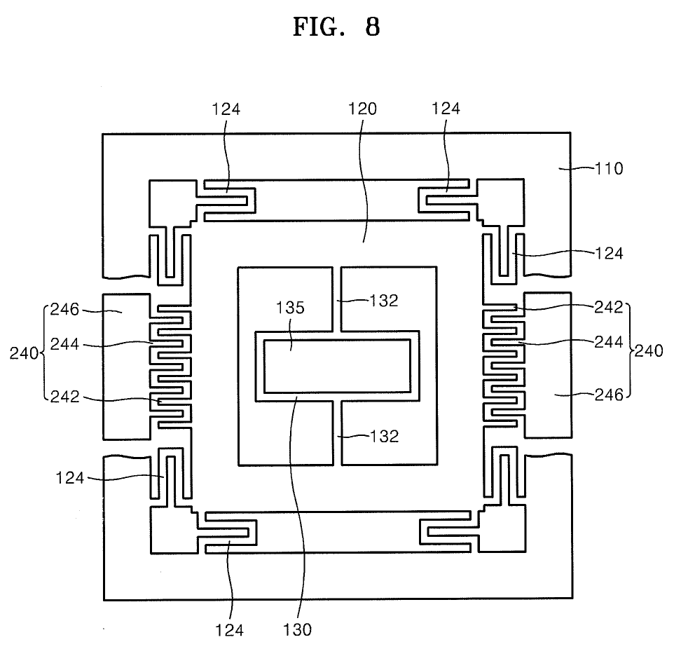

FIGS. 6 and 7 are plane views illustrating modified examples of the MEMS scanner of FIG. 1, and FIG. 8 is a plane view illustrating a modified example of the MEMS scanner of FIG. 4.

Referring to FIGS. 6 and 7, in the MEMS scanner of FIG. 1, a first tortional spring 124 connecting the stationary frame 110 and the first movable stage 120 may have a folded shape. Two first tortional springs 124 may be provided at each of two facing edges of the first movable stage 120, as illustrated in FIG. 6, or two first tortional springs 124 may be provided at each of four edges of the first movable stage 120, as illustrated in FIG. 7.

Referring to FIG. 8, even in the MEMS scanner of FIG. 4, a first tortional spring 124 connecting the stationary frame 110 and the first movable stage 120 may have a folded shape. Two first tortional springs 124 may be provided at each of four edges of the first movable stage 120 or only at each of two facing edges of the first movable stage 120. When two first tortional springs 124 are provided at each of four edges of the first movable stage 120, as illustrated in FIG. 8, the movable combs 242 of the electrostatic actuator 240 may be disposed between two first tortional springs 124.

As described above, when the first tortional spring 122 has a folded shape, the first movable stage 120 can be more stably and firmly supported such that structural reliability is improved.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A microelectromechanical systems (MEMS) scanner comprising:
a stationary frame;
a first movable stage disposed inside the stationary frame and suspended on the stationary frame so as to pivot and vibrate around a virtual center shaft of the MEMS scanner;
a second movable stage disposed inside the first movable stage and suspended on the first movable stage so as to pivot and vibrate around the center shaft; and
an actuator providing a driving force used to pivot and vibrate the first movable stage.

2. The MEMS scanner of claim 1, wherein the first movable stage is directly driven by the actuator and the second movable stage is indirectly driven by driving the first movable stage.

3. The MEMS scanner of claim 1, wherein a reflection surface from which incident light is reflected is provided on at least one of an upper surface and a bottom surface of the second movable stage.

4. The MEMS scanner of claim 1, wherein the stationary frame, the first movable stage and the second movable stage are formed on one silicon substrate as one body.

5. The MEMS scanner of claim 1, wherein the stationary frame and the first movable stage are connected to each other by at least one first tortional spring disposed therebetween, and the first movable stage and the second movable stage are connected to each other by at least one second tortional spring disposed therebetween.

6. The MEMS scanner of claim 5, wherein the first tortional spring has larger rigidity than the second tortional spring.

7. The MEMS scanner of claim 5, wherein the first tortional spring and the second tortional spring are placed on the center axis and have a shape of a bar extending along the center axis.

8. The MEMS scanner of claim 7, wherein the first tortional spring has a larger thickness than the second tortional spring.

9. The MEMS scanner of claim 5, wherein the first tortional spring has a folded shape.

10. The MEMS scanner of claim 9, wherein two first tortional springs are provided at each of two facing edges of the first movable stage.

11. The MEMS scanner of claim 9, wherein two first tortional springs are provided at each of four edges of the first movable stage.

12. The MEMS scanner of claim 1, wherein the actuator is an electromagnetic actuator comprising permanent magnets and an electromagnet.

13. The MEMS scanner of claim 12, wherein the permanent magnets are attached to each of two sides of the bottom surface of the first movable stage.

14. The MEMS scanner of claim 13, wherein the permanent magnets are attached to the first movable stage so that same magnetic poles point in the same direction.

15. The MEMS scanner of claim 13, wherein the electromagnet comprises a core and a coil wound around the core, and two ends of the core face each other and are spaced apart from each of the permanent magnets by a given distance.

16. The MEMS scanner of claim 1, wherein the actuator is an electrostatic actuator comprising movable combs and stationary combs.

17. The MEMS scanner of claim 16, wherein the stationary combs are disposed at different heights with respect to the moveable combs in a vertical direction so that an electrostatic force is applied to the movable combs in the vertical direction.

18. The MEMS scanner of claim 17, wherein the actuator further comprises stationary stages disposed below two sides of the first movable stage and supporting the stationary combs.

19. The MEMS scanner of claim 18, wherein the movable combs protrude from the two sides of the first movable stage in a horizontal direction and the stationary combs protrude from two sides of the stationary stages in the horizontal direction, and are disposed not to overlap the movable combs.
